(19) United States
(12) Patent Application Publication
(10) Pub. No.: US 2015/0259493 A1
(43) Pub. Date: Sep. 17, 2015

(54) Polymer Foam Comprising a Polymer and Nanoparticles, and Nanoparticles for the Manufacture of Such Foam

(71) Applicant: UT INTERNATIONAL VENTURES HOLDING B.V., Enschede (NL)

(72) Inventors: Paulus Hendricus Johannes Nederkoorn, Enschede (NL); Joost Duvigneau, Winterswijk (NL); Julius Vancso, Hengelo (NL); Toine Wassing, Nijmegen (NL)

(21) Appl. No.: 14/441,094

(22) PCT Filed: Nov. 8, 2013
(86) PCT No.: PCT/NL2013/050794

§ 371 Date: May 6, 2015

(30) Foreign Application Priority Data
Nov. 9, 2012 (NL) 2009777

(51) Int. Cl. C08J 9/12; C08J 9/00

(52) U.S. Cl. CPC C08J 9/122; C08J 9/008; C08J 2371/00; C08J 2325/06; C08J 2383/06

(57) ABSTRACT

A polymer foam is produced comprising a polymer and nanoparticles having a maximum dimension of 750 nm, which foam has cells with an average cell size of at most 1 μm and a cell density of at least 10¹² cells/ml, wherein polymeric grafts have been attached to the nanoparticles. The nanoparticles may be particles with a solid core or porous hollow core-shell particles. The foam can be manufactured by dispersing the nanoparticles in a polymer to yield a dispersion; by adding a blowing agent to the dispersion to obtain an expandable mixture; and by foaming the expandable mixture to obtain the polymer foam.

The present invention relates to a polymer foam comprising a polymer and nanoparticles, and nanoparticles that are suitable for the manufacture of such foam.

Polymer foams with small pores (nanopores) have found a wide range of applications. Examples include use thereof in mass transport applications such as membranes where open interconnected nanoporous networks offer the design of (ultra-)microfiltration membranes. They may also be used in drug delivery systems. Besides these applications polymer foams due to their high internal volume can be used as absorbents for oil spills, diaper filler, etc. or as support for catalysts, where the incorporated nanopores offer a large exposed available surface area. Due to the incorporation of many nanopores bulk material properties can remain in the accepted performance window while offering weight and thus costs reduction for manufacturers. This is particular of interest in areas such as packaging and the automotive industry. The introduction of gas/air filled nanopores also results in lowering the dielectric constant of the material which is desirable for instance in developing Micro-Electro Mechanical Systems applications and electrical insulation. The effectiveness of the above-mentioned applications would be increased by the provision of polymer foams with a high porosity and pore cell sizes below 1 μm.

Polymer foams are further widely used for thermal insulation purposes. Examples of conventional insulation materials include expanded polystyrene and polyurethanes. In insulation applications these materials compete with another insulation material constituted by aerogels. Aerogels are lightweight dried gels with a high porosity. Most aerogels are based on silica. The structure of silica based aerogel consists of small spherical silica clusters with a diameter of a few nanometers which are linked to each other and form chains resulting in a spatial grid with air filled pores. The average pore size may be as low as about 30 to 40 nm. Aerogels have a high porosity which implies very thin walls between the cells. Due to this small cell size and high porosity the thermal insulation capacity of aerogel both against convection, conduction and also to some extent radiation is excellent. Aerogels, however, are very fragile. A typical way to handle aerogel is in the form of impregnated blankets. However, these flexible blankets tend to cause dust. In many insulation applications the use of solid, rigid plates is preferred over the use of flexible blankets. Moreover, aerogels are expensive. Therefore, there has been a lot of research efforts dedicated to investigate whether it would be possible to modify polymer foams that tend to have a rather high strength, such that they also have a small cell size and a high porosity.

It has been described that polymer nanocomposites possess high potential to achieve property improvements by adding a small amount of nanoparticles in polymer matrices. In U.S. Pat. No. 7,812,072 a polymer nanocomposite is described comprising styrene polymer and silica nanoparticles.

A further investigation has been described in an article by J. Yang et al., J. Supercritical Fluids, 62 (2012) 197-203. According to this journal article silica particles were synthesized with average particle sizes of 50, 150 and 250 nm. The silica particles were then functionalised with 3-aminopropyl triethoxysilane and subsequently with 2-bromobutyrate, which was then followed by the grafting of a polyionic liquid. These nanoparticles were used in the foaming of polystyrene. It was found that the cell sizes for foams that were obtained with silica particles without polyionic liquid ranged from 15.8 to 16.7 μm. The cell density did not change significantly compared with polystyrene foam that was obtained without any silica particles. The cell density was about 1.1*10⁹ cells/cm³. When the foaming was done with polyionic liquid modified silica particles the cell size was reduced by a factor two and was about 8.0 μm. The cell density could be increased to about 2.8*10⁹ cells/cm³.

This finding is in conformity with the teachings of an article by K. Goren et al., J. Supercritical Fluids, 51 (2010) 420-427, wherein it has been described that the addition of tethers (or grafts) to the surface of nanoclays doubles the nucleation density, which leads to a doubling of the cell density. In addition to the fact that these known silica particles contain grafts that are difficult and expensive to manufacture and that carbon dioxide at supercritical pressure is used, the particles fail to significantly increase the cell density and reduce the average cell size of the eventual polymer foam to a value that comes close to the cell size in aerogels.

It is evident that there is a need to have polymer foams available that show improved properties as to cell sizes. Surprisingly, the present inventors have found ways to produce polymer foams having cell sizes of at most 1 μm and a high porosity in terms of number of cells per ml.

WO 2011/066060 discloses a polymeric foam article having a thermoplastic polymer matrix defining multiple cells therein, wherein the polymeric foam article has the following characteristics: (a) the thermoplastic polymer matrix contains dispersed within it nano-sized nucleating additive particles that have at least two orthogonal dimensions that are less than 30 nanometers in length; (b) possesses at least one of the following two characteristics: (i) has an effective nucleation site density of at least 3×10¹⁴ sites per cubic centimeter; and (ii) has an average cell size of 300 nanometers or less. The nucleating additive may be selected from silica, magnesium oxide, zirconium oxide, calcium carbonate, calcium oxide, titanium dioxide, crystalline materials (for example salt and sugar) and polymeric nanoparticles. According to this patent application the nano-sized particles must have a size of at most 30 nm. The foam articles are produced by providing a foamable composition at foaming temperature and initial pressure and rapidly depressurizing. The initial pressure is very high, in the order of 24 to 32 MPa. It has now been found that nanoparticles that may have a size as large as 750 nm can yield a polymer foam with a cell density of at least 10¹² cells/cm³ and a cell size of at most 1 μm at significantly lower pressures, if the nanoparticles have grafts.

Accordingly, the present invention provides a polymer foam comprising a polymer and nanoparticles having a maximum dimension of 750 nm, which foam has cells with an average cell size of at most 1 μm and a cell density of at least 10¹² cells/ml, wherein polymeric grafts have been attached to the nanoparticles.

The inventors have found that the use of certain nanoparticles in the manufacture of polymer foams, which nanoparticles have a maximum dimension of 750 nm and comprise certain grafts, in particular grafts with a number average molecular weight (Mn) of at least 400, yields polymer foams with small average cell sizes and high porosity. The polymer in the polymer foam may be present as a polymer matrix wherein the nanoparticles have been dispersed, in a way similar to the foam according to U.S. Pat. No. 7,812,072. However, it is also possible to provide for the polymer in the foam by linking nanoparticles via grafted polymer chains that are attached to the nanoparticles, thereby building a foam comprising a network of nanoparticles connected via the polymer. In this way the combination of grafts that are attached to the nanoparticle constitutes the polymer in the polymer foam. Optionally, additional free polymer, i.e. polymer that is not grafted to the nanoparticles, may be present. It is considered that especially such polymer foams have excellent thermal insulation properties.

The polymer foam can suitably be obtained by using nanoparticles to which polymeric grafts have been attached and which have a maximum length of 750 nm, wherein the polymeric grafts have been made of an optionally substituted polymer selected from polystyrene, polyacrylate, polymethacrylate, polyolefins, in particular polyethylene, polypropylene and polybutylene, polyurethanes, polyalkylene oxides, silicones, such as polydimethylsiloxanes and combinations thereof. The combinations may constitute random or block copolymers. Moreover, the polymers may comprise monomers that contain halogen substituents. Preferably, polymeric grafts comprise polyolefins or polyethers that comprise halogen atoms, more preferably comprise fluorine atoms.

The foam according to the present invention also contains nanoparticles. It has been found that such a foam is also obtainable if the nanoparticle is a porous hollow core-shell particle with a maximum size of 750 nm. In particular, it is preferred to employ spherical particles with a hollow interior and a mesoporous shell. Hollow spheres with a mesoporous shell may be prepared via a sol-gel process in accordance with the method as described in H. Fan et al., Materials Letters, 6 (2006) 1811-1814. Although these particles were prepared for slow release drug delivery, it was surprisingly found that the particles also enabled the provision of the polymer foam according to the present invention.

These hollow core-shell particles also comprise grafts. However, it has been found that the foam according to the present invention can also be obtained by using nanoparticles which comprise a solid core to which polymeric grafts have been attached. The nanoparticle can be prepared from a variety of materials. Suitably the nanoparticles comprise a substance selected from metals, metal oxides, metal salts and combinations thereof. Although the metal can be chosen from a wide variety of metals from the Periodic Table of the Elements, it is preferred to select them from the groups 1a, 2a, 4b, 8, 1b, 2b, 3a and 4a. The anions in the salts may be selected from a wide variety, including from the sulphates, carbonates, nitrates and organic carboxylates, such as maleates, oxalate etc., and combinations thereof. In particular, the nanoparticles suitably comprise a substance selected from the metals, oxides and salts of Ca, Mg, Zr, Ti, Zn, Sn, Ce, Fe, Al, Cs, Cu, Ag and combinations thereof, such as calcium carbonate, magnesium oxide, ferric oxide and ferrous oxide, caesium oxide, cerium oxide, cupric oxide, cuprous oxide and silver oxide.

Especially preferred the nanoparticles are made of a substance selected from silica, alumina, titania, zirconia, polymers and combinations thereof. Silica is a preferred material since it is abundantly available and the preparation for making silica particles of the desired size is known in the art. Moreover, silica nanoparticles containing hydroxyl sites are readily prepared and can be used for attaching grafts to the particle, as is known in the art.

Nanoparticles that have been provided with grafts enable the manufacture of the foam according to the invention. These grafts have been made from one or more polymeric materials.

The grafts can be derived from polymers that have been made via a number of polymerisation methods. Suitable polymerisation methods include addition polymerisation and condensation polymerisation. Examples of polymers obtainable via addition polymerisation include any monomer that includes a polymerisable double bond such as polyolefins or polystyrene. Examples of condensation polymerisation polymers include polyesters, polyurethanes, polyamides and polyethers. Advantageously, the grafts have been made of a polymer selected from polystyrene, polyacrylate, polymethacrylate, polyurethanes, polyalkylene oxides, polyolefins, preferably polyethylene, polypropylene and polybutylene, silicones, such as polydimethylsiloxanes, and combinations thereof, in particular of polystyrene, polyurethanes, polyalkylene oxides, polyolefins, preferably polyethylene, polypropylene and polybutylene, silicones, such as polydimethylsiloxanes, and combinations thereof.

When acrylates or methacrylates are used in the polymers, they preferably are the acids or the esters of groups with 1 to 8 carbon atoms.

The grafts may be prepared in advance and subsequently be attached. Alternatively, the grafts may be prepared on the nanoparticle. In the latter case such can e.g. be achieved by attaching an initiator to the nanoparticle and have monomers polymerise via these initiators in an addition polymerisation. It is also possible to attach a first molecule to the particle and subsequently use these molecules for a condensation polymerisation.

The grafts that are attached to the nanoparticle may be connected with each other by means of crosslinks. Thereto, the grafts may be prepared with crosslinkable monomers, such as diolefins or may comprise reactive groups such as carboxylic, hydroxylic or amino groups.

It has been found that it is advantageous when the polymers of the grafts have a low surface energy. It is believed that a low surface energy of the polymer grafts provides a good heterogeneous nucleation layer. Therefore, it is advantageous to use a polyether such as polyalkylene glycols, wherein the alkylene is suitably ethylene, trimethylene, propylene, butylene or tetramethylene, polytetrahydrofuran, but also silicones, such as polydimethylsiloxane. It is also possible to use a polymethacrylate with a linear or branched alkyl group as the ester group having 2 to 6 carbon atoms, such as polyethylmethacrylate, polybutylmethacrylate, poly(isobutyl)methacrylate or polyhexylmethacrylate.

According to the present invention the grafts preferably contain halogen atoms. Due to the presence of halogens, the surface energy is lowered, which has a beneficial effect on the cell size and porosity of the eventual polymer foam. The halogen atoms can be selected from any halogen, but it is preferred to use chlorine or fluorine, with fluorine being particularly preferred. Therefore, the halogen-containing grafts preferably contain fluorine substituents. Combinations of different halogens may also be used. A suitable example is polychlorortrifluoroethylene. Other halogenated and perhalogenated monomers can also be used. Another good example is polytetrafluoroethylene. Preferably, the fluorine substituents-containing polymeric grafts comprise perfluoropolyalkylene oxide moieties.

It is particularly advantageous to use perfluoropolyethers of the general formula

R¹—CF₂O—(CF₂—CF₂—O)ₚ—(CF₂O)_{q}—CF₂—R²

wherein R¹ and R² independently represent R³O—CH₂—, wherein R³═H or an alkyl group having from 1 to 3 carbon atoms; R⁴—COO—, wherein R⁴=an alkyl group having from 1 to 3 carbon atoms; R⁵—O—CH₂CH(OH)—CH₂—O—CH₂—, wherein R⁵═H or an alkyl group having from 1 to 3 carbon atoms; or R⁴—CO—, R³—O—(CH₂CH₂O)ₙ—CH₂—, wherein n is in the range from 1 to 3, and p and q are in each case in the range from 1 to 25, in particular from 3 to 12.

Examples of suitable grafts comprising perfluoropolyethers are perfluoropolyether diols with formula H(OCH₂CH₂)ₘ—OCH₂—CF₂O—(C₂F₄O)ₚ—(CF₂O)_{q}—CF₂CH₂O—(CH₂CH₂O)ₘH, or formula HOCH₂—CF₂O—(CF₂CF₂O)ₚ—(CF₂O)_{q}—CF₂—CH₂OH, wherein m is 1 or 2, p and q are at least 2, suitably vary from 3 to 25, and a perfluoropolyether diester with a formula R⁶OOC—CF₂O—(C₂F₄O)ₓ—(CF₂O)_{y}—CF₂—COOR⁶, wherein R⁶ is an alkyl group with 1 to 6 carbon atoms, ethyl being preferred, and x and y are at least 2 and may vary from 2 to 25.

The surface energy may further be reduced by modifying the surface of the particle. Therefore, the particle surface may be modified, advantageously by covalent derivatization of the particle with a low surface energy compound before the grafts are attached thereto. A very useful compound is selected from the group of silanes. It is believed that the silylation of the surface of the particle promotes the formation of bubbles of blowing agent, which facilitates the nucleation of the blowing agent bubble. Therefore, the particle has advantageously been modified by applying a silane compound, preferably a fluorine substituents-containing silane compound on the particle.

The length of the grafts, in Dalton, may be selected from wide ranges. Long-chain grafts may benefit the maintenance of distance between particles which may facilitate nucleation. These long-chain grafts tend to be difficult to prepare. Excellent foams have been obtained when the graft has a particular length, as expressed in Dalton. Suitably, the grafts have a number average molecular weight ranging from 400 to 100,000 Dalton. Very good results have been obtained with grafts having a molecular weight ranging from 400 to 50,000 Dalton. In certain embodiments, especially when a polymer matrix is used, the grafts may preferably have a number average molecular weight of 400 to 5,000.

The amount of the polymeric grafts on the nanoparticle may vary within wide ranges. The amounts of the polymeric grafts is suitably determined via Thermal Gravimetric Analysis (TGA). The amount of the polymeric grafts suitably ranges from 1 to 90% wt, suitably from 2 to 50% wt, based on the weight of the nanoparticle. A meaningful parameter is the grafting density, indicating the number of grafts per nm². In determining the grafting density, the weight of the grafts per gram nanoparticle is being established by means of TGA. On the basis of the measured diameter of the nanoparticle without grafts, as determined by SEM (Scanning Electron Microscopy), the surface is calculated (assuming spherical particles and a predetermined density of the material of the nanoparticle). The number average molecular weight of the grafts is then determined and using these data, the number of chains (grafts) per nm² is calculated. Suitable grafting densities range from 0.01 to 0.8 nm⁻².

The shape of the nanoparticles may vary. Hence, it is possible to have particles with a rectangular, elliptical or circular dimension. Preferably, the aspect ratio of the nanoparticle is at most 10, the aspect ratio being defined as the ratio between the largest dimension (length) of the particle divided by the smallest dimension being either the thickness or the width of the nanoparticle. In this way the nanoparticle is preferably as compact as possible. Most advantageously, the nanoparticles are substantially spherical, more in particular, the nanoparticles comprise substantially spherical silica particles.

When the polymer foam comprises a polymer matrix the polymer that forms the matrix for the foam according to the present invention can be selected from a wide variety of polymeric materials. The skilled person will realise that many different polymers can be used to provide the insulating material that is being desired. Good results are obtainable with polymers matrices selected from polyolefins, polyesters, polystyrene, polyacrylates, polymethacrylates, polyalkylene oxides, polyurethanes, polyamides and combinations thereof. Polystyrene, and in particular expanded polystyrene, is known as insulation material. It is light, rigid and cheap and due to the application of the nanoparticles according to the present invention polystyrene plates and granules can be excellently used as the polymer matrix in the foam according to the present invention.

The foam according to the present invention contains at least the polymer and nanoparticles. Typically, the amount of nanoparticles can be selected by the person skilled in the art without undue difficulty. Advantageously, the amount of nanoparticles in the foam may be from 0.1 to 95% wt, based on the combination of polymer and nanoparticles. When a polymer matrix is used, the amount of nanoparticles preferably ranges from 0.2 to 10% wt, based on the combination of polymer matrix and nanoparticles.

The foam according to the invention comprise cells that have an average cell size of at most 1 μm. The cell size is determined in accordance with the standard ASTM D 3576. The invention further enables the obtaining of polymer foam with an average cell size of at most 750 nm, preferably at most 550 nm. In addition, the foam has a cell density of at least 10¹² cells/ml. This constitutes a significant advancement compared to the cell density that could be obtained by the grafted silica particles according to the article by J. Yang et al. where the cell density varied between about 1.1*10⁹ cells/cm³ and about 2.8*10⁹ cells/cm³. The cell density is determined according to a procedure described by Tomasko et al., Polymer Engineering and Science 2002, 42 (11), 2094-2106.

The invention further provides nanoparticles, which have a maximum dimension of 750 nm and to which polymeric grafts have been attached and, wherein the polymeric grafts suitably have been made of an optionally substituted polymer selected from polystyrene, polyacrylate, polymethacrylate, polyolefins, in particular polyethylene, polypropylene and polybutylene, polyurethanes, polyalkylene oxides, silicones, such as polydimethylsiloxanes, and combinations thereof. The polymeric grafts have more preferably been made of an optionally substituted polymer selected from polystyrene, polyolefins, in particular polyethylene, polypropylene and polybutylene, polyurethanes, polyalkylene oxides, silicones, such as polydimethylsiloxanes, and combinations thereof. Advantageously, the polymeric grafts comprise polyolefins or polyethers that comprise halogen atoms, more preferably that comprise fluorine. When the nanoparticles are used in a polymer foam that also comprises a polymer matrix, it is advantageous when the polymer of the polymer matrix differs from the polymer of the polymeric grafts. It is believed that this may be caused by the absence of a difference in surface energy when both polymers are the same. When the surface energies are different this may result in smaller cell sizes and/or higher cell densities of the polymer foam obtained.

As indicated above, the nanoparticles that are suitable for the manufacture of the foam according to the present invention have a maximum dimension (length) of 750 nm. Preferably, the nanoparticles have a maximum length of 500 nm. In accordance with the statements above, the nanoparticles, which may be porous hollow core-shell particles, are preferably made of a substance selected from silica, alumina, titania, zirconia, polymers and combinations thereof. Preferred embodiments of the nanoparticles have already been described above in connection with the foam which is obtained from the use of such nanoparticles.

Accordingly, the present invention also provides the use of a nanoparticle according to the present invention in the manufacture of a polymer foam having cells with an average cell size of at most 1 μm and a cell density of at least 10¹² cells/ml.

The invention further provides a method for the manufacture of polymer foams according to the present invention, comprising

dispersing nanoparticles having a maximum dimension of 750 nm, to which nanoparticles polymeric grafts have been attached and, wherein the polymeric grafts have suitably been made of an optionally substituted polymer selected from polystyrene, polyacrylate, polymethacrylate, polyolefins, polyurethanes, polyalkylene oxides, silicones and combinations thereof, in a polymer to yield a dispersion;

adding a blowing agent to the dispersion to obtain an expandable mixture; and

foaming the expandable mixture to obtain the polymer foam.

As stated above the nanoparticles may have a solid core and may also comprise a porous hollow core-shell particle.

The dispersion can be obtained by dispersing the nanoparticles in the polymer in various ways. Suitable ways include solution blending or melt blending or a combination thereof.

The blowing agent that is used in the above-described manufacture can be selected from any blowing agent that is known in the art. It can be a physical blowing agent or a chemical blowing agent. Examples of physical blowing agents include carbon dioxide, nitrogen, water, argon and low-boiling hydrocarbons such as propane, butane or pentane. Suitable chemical blowing agents include sodium bicarbonate and azobicarbonamide. The blowing agents may be added to the polymer simultaneously with the nanoparticles, which is especially the case when chemical blowing agents are used, or after the forming of the dispersion of polymer and nanoparticles.

The blowing agent may be added to yield the expandable mixture at pressures within a wide range. A suitable range includes from 10 to 200 bar, although higher pressures are feasible. Preferably, the pressure is in the range of 20 to 100 bar.

The method preferably further includes foaming conditions, which include a pressure drop in case of physical blowing agents and a decomposition of blowing agent in case of chemical blowing agents. Such process steps are known to the skilled person. By applying the above method for the manufacture of polymer foams, including the use of the nanoparticles of the present invention, a foam with an average cell size of at most 1 μm and a cell density of at least 10¹² cells/ml is obtained. In certain embodiments, especially when grafted nanoparticles constitute the majority of the polymer foam, wet-chemical approaches known by the skilled person can be used to obtain a polymer foam according to the present invention.

The invention will be further elucidated by means of the following examples.

### EXAMPLE 1

### Experiment 1

### Preparation of Silica Nanoparticles: Method 1

A 500 ml round bottom flask was filled with 168 ml of ethanol, 28 ml of water and 30 ml of tetraethyl orthosilicate (TEOS), whilst stirring the solution at 500 rpm using a magnetic stirrer. Subsequently, 2 ml of a 30%-ammonium hydroxide solution was added to increase the pH of the solution to a value of about 10. The mixture was stirred for 1.5 hour. Silica particles were formed. Subsequently, the slightly opaque mixture was centrifuged for 30 min at 10,000 rpm. The particles were re-dispersed in 2-propanol to remove unreacted TEOS and the particles were centrifuged a second round at 10,000 rpm for 30 min. Washing with 2-propanol was repeated once more, after which the particles were centrifuged at 10,000 rpm for 30 min, collected and dried in vacuo at room temperature for over 2 hours.

The average particle size was determined by using High-Resolution Scanning Electron Microscopy (HR-SEM). The silica nanoparticles were substantially spherical and had an average particle size (diameter) of 98±16 nm.

### Experiment 2

### Preparation of Porous Hollow Core-Shell Silica Nanoparticles: Method 2

In a 1000 ml round bottom flask, an 8 wt % calcium carbonate suspension was prepared by adding 24 g nano-sized calcium carbonate particles into 277 ml water whilst constantly stirring at 500 rpm. Subsequently, 2.4 g of cetyl trimethyl ammonium bromide (CTAB) was added to the calcium carbonate suspension followed by heating to 70-90° C., whilst stirring at 500 rpm. Subsequently, a 2 wt % NaSiO₃.9H₂O solution was added drop wise over a period of 2 hours. The pH of the suspension was adjusted to 9-10 by constantly adding a 10 wt % hydrochloric acid solution. The mixture was left to stir for 2 hours and subsequently cooled to room temperature, filtered, rinsed with distilled water and dried at 100° C. for 12 hours in an oven. After drying, the particles were calcined in air at 700° C. for 5 hours to yield a core-shell composite with CaCO₃ as the core and porous silica as the shell. Following this heat treatment, calcium carbonate was removed from the composite by immersing the suspension in a 3 wt % hydrochloric acid solution (24.3 ml of 37% HCl in 276 ml water) for 10 hours. Subsequently, nanoparticles were collected by vacuum filtration, washed thoroughly with water and dried in a vacuum oven at 80° C. for 12 hours to produce porous hollow core-shell silica nanoparticles.

The particle size of the silica nanoparticles obtained was measured using dynamic light spectroscopy. The silica particles clustered together to form aggregates. The average particle size of the aggregates was 3.2±0.6 μm.

These particles were redispersed in an aqueous solution comprising a surfactant, i.e. Span 80 (sorbitan monooleate). Upon redispersion the aggregates decomposed and nanoparticles with an average particle size (diameter) of 232 nm±6 nm were obtained.

### Experiment 3

### Functionalization of Silica Nanoparticles by Attaching Grafts to Silica Particles

Silica nanoparticles were functionalized with two types of fluoropolymer, viz. Fluorolink D10/H (perfluoropolyether of formula HOCH₂—CF₂O—(CF₂CF₂O)ₚ—(CF₂O)_{q}—CF₂—CH₂OH, having a mean molecular weight of about 1500) and Fluorolink E10/H (perfluoropolyether with ethylene glycol end groups of formula H(OCH₂CH₂)ₘ—OCH₂—CF₂O—(C₂F₄O)ₚ—(CF₂O)_{q}—CF₂CH₂O—(CH₂CH₂O)ₘH, with a mean molecular weight of about 1700), both available from Solvay Solexis. To functionalize the silica nanoparticles obtained from Experiment 1 and the porous hollow core-shell silica nanoparticles of Experiment 2 with fluoropolymer, about 1.4 g of silica nanoparticles of either Experiment were dispersed in 15 ml FluorolinkD10/H in a 50 ml round bottom flask. The same was done for the modification of the silica nanoparticles of both Experiments with Fluorolink E10/H. The samples were heated to 150° C. whilst stirring overnight. Subsequently, the samples were cooled and washed with nonafluorobutyl methyl ether for 1.5 hours. The samples were centrifuged for 20 min at 6000 rpm, and dried at 100° C. in vacuo for over 2 hours.

Via Fourier Transform Infra-Red (FTIR) Spectroscopy the particles were analysed. The FTIR spectrum showed a characteristic absorption band of C—F at 1180 cm⁻¹, indicating that both fluoropolymers have reacted with the surface silanol groups of the silica nanoparticles. The particles were analysed for the content of fluoropolymer in the functionalised particles using Thermal Gravimetric Analysis. It appeared that the silica nanoparticles according to Experiment 1 contained 5.1% wt of Fluorolink D10/H and 6.9% wt of Fluorolink E10/H. The grafting density was 0.63 and 0.77, respectively. The content of Fluorolink D10/H in the silica aggregates of Experiment 2 was 46.4% wt, and the content of Fluorolink E10/H in the silica aggregates of Experiment 2 was 48.2% wt.

### Experiment 4

### Nanoparticle Polystyrene Composite

In a small extruder the nanoparticles were mixed with polystyrene. The nanoparticles prepared were mixed into the polystyrene matrix at different weight percentages: 4, 2 and 1 wt %, respectively, based on the total of nanoparticles and polystyrene. A total amount of 5 g (polymer+nanoparticles) was loaded into the extruder and was mixed for 10 minutes at a temperature of 155° C. and a screw speed of 100 rpm. Also, a sample of pure polystyrene was prepared with the extruder. Subsequently, 200 μm thick films were prepared from the extruded nanocomposite samples by using a hot press. The samples, 4×2 cm and 4×3 cm, were pressed at 130° C. with a force of 250 kN for 10 minutes.

### Experiment 5

### Foaming Process

The hot pressed polymer nanocomposite films were cut into 1×1 cm samples. The samples were saturated with CO₂ for 90 minutes in a gas cylinder. Saturation was done at 58 bar. After saturation, the pressure was released and the samples were transferred to a glycerol bath set at a temperature of 100° C. After 30 s, the samples were removed from the glycerol bath and quenched in a 50:50 water-ethanol bath at room temperature. Then the samples were kept in ethanol for about 1 hour. The films were blow-dried in a nitrogen stream and stored in vacuo overnight to remove the last traces of water and ethanol. The samples were analysed for cell size and cell density. The results are shown in Table 1 below. In the Table the particles from Experiment 1 have been designated as “S1”, and the particles from Experiment 2 have been identified as “S2”. The perfluoropolymer grafts have been identified by the Fluorolink codes “D10/H” and “E10/H”, respectively. For comparison reasons a foaming experiment with a similar polystyrene film was carried out, which polystyrene film did not contain any nanoparticle. The results of this experiment are shown as Experiment No. 5o.

TABLE 1

| Exp. | | polymer | amount of | | Cell density, |
|---|---|---|---|---|---|
| No. | Silica | graft | nanoparticles, % wt | Cell size, μm | 10¹² cells/ml |
| 5a | S1 | — | 4 | 1.0 | 0.7 |
| 5b | S1 | D10/H | 4 | 0.6 | 2.8 |
| 5c | S1 | E10/H | 4 | 0.5 | 2.0 |
| 5d | S2 | — | 4 | 0.7 | 2.8 |
| 5e | S2 | D10/H | 4 | 0.5 | 2.4 |
| 5f | S2 | E10/H | 4 | 0.6 | 1.0 |
| 5g | S1 | — | 2 | 1.1 | 0.8 |
| 5h | S1 | D10/H | 2 | 0.7 | 1.7 |
| 5i | S2 | — | 2 | 0.6 | 2.6 |
| 5j | S2 | D10/H | 2 | 0.6 | 3.0 |
| 5k | S1 | D10/H | 1 | 0.8 | 1.0 |
| 5l | S2 | — | 1 | 0.6 | 1.3 |
| 5m | S2 | D10/H | 1 | 0.5 | 5.4 |
| 5n | S2 | E10/H | 1 | 0.7 | 9.0 |
| 5o | — | — | — | 2.2 | 0.08 |

The above experiments show that in comparison with blown polymer matrices that have been derived from silica particles S1 without polymer grafts, the polymer foams according to the invention (i.e. experiments 5b, 5c, 5h and 5k) present a reduced cell size, below 1 μm, and at the same time an increase in the number of cells per ml above a value of 10¹². For silica particles that consist of porous hollow core-shell particles (S2) it appears that these particles enable the provision of polymer foams with a cell size below 1 μm and a cell density of at least 10¹² cells/ml, independent of the presence or absence of grafts. However, when grafts are attached to these particles the cell size is decreased and/or the cell density is increased.

In contrast therewith experiment 5o shows that when the polystyrene foam does not contain nanoparticles the cell size and the cell density are unsatisfactory.

Experiments 5a and 5g also show that when solid silica nanoparticles without grafts are used the desired cell density is not achieved and the cell size is at or above 1 μm.

### EXAMPLE 2

### Experiment 6

### Silanol-Functionalized Silica Particles

To introduce silanol (Si—OH) groups on the surface of the prepared silica nanoparticles as prepared according to Method 1 of Experiment 1 and having an average particle size of 80 nm, the particles were redispersed in water (Milli-Q®) by sonication for 1 hour. Hydrochloric acid was added to the mixture, while stirring at 500 rpm, until the pH of the solution reached a value of approximately 1. After 4 hours the mixture was centrifuged at 10,000 rpm for 30 min. The supernatant was replaced by Milli-Q water in order to redisperse the hydrolyzed nanoparticles. Centrifugation and washing with Milli-Q water was repeated once more. Subsequently the silanol functional nanoparticles were collected and dried in a vacuum (membrane pump) at room temperature for more than 4 hours. The presence of silanol groups was confirmed with Fourier Transform Infra-Red (FTIR) Spectroscopy.

### Experiment 7

### Functionalization of Silica Nanoparticles by Attaching Siloxane Grafts to Silica Particles

In a 100 ml round bottom flask, 100 mg silanol-functionalized silica nanoparticles as prepared above were mixed with 20 ml THF by sonication for 30 min followed by stirring for 1 hour. Subsequently, a catalytic amount of SnCl₂ and 4.0 gram of mono-glycidyl ether terminated polydimethylsiloxane (PDMS-G) with a molecular weight of about 5000 Dalton were added to the flask. The reaction flask was immersed in an 80° C. thermostated oil bath and the reaction mixture was stirred at 500 rpm under a nitrogen atmosphere for 4 hours. Following centrifugation at 10,000 rpm for 30 min, the supernatant was replaced by THF and the particles were redispersed. This centrifugation and redispersion in THF step was repeated twice and finally the PDMS-grafted silica nanoparticles were dried in vacuum. The presence of PDMS was confirmed with FTIR spectroscopy. By thermo gravimetric analysis the amount of PDMS-G grafted to the silica nanoparticles was determined to be 2.4% wt. The grafting density was calculated and determined to be 0.07 PDMS chains per nm².

### Experiment 8

### Functionalization of Silica Nanoparticles by Attaching Siloxane Grafts to Silica Particles

In a 100 ml round bottom flask, the silanol-functionalized silica nanoparticles as prepared above (2.0 g) in Experiment 6, were redispersed in 100 ml ethanol by sonication for 1 hour followed by the addition of 10 ml (3-aminopropyl)-trimethoxysilane (APTMS). This reaction mixture was stirred at 500 rpm for 17 hours. The thus amine-functionalized nanoparticles were centrifuged at 10,000 rpm for 30 min. The supernatant was replaced by ethanol in order to redisperse the nanoparticles. Centrifugation and washing with ethanol was repeated twice. The collected amine-functionalized nanoparticles were dried in vacuum at room temperature for more than 12 hours. The presence of amino groups was confirmed with Fourier Transform Infra-Red (FTIR) Spectroscopy.

In a 100 ml round bottom flask, 1 gram of thus amine-functionalized silica nanoparticles were mixed with 20.5 ml THF and 15 g of PDMS-G with a molecular weight of about 5000 Dalton and left to stir for more than 51 hours followed by sonication for one hour. Subsequently, the solvent was removed from the mixture by rotary evaporation and the resulting silica nanoparticle dispersion in PDMS-G was stirred at 500 rpm under a nitrogen atmosphere for 30 min. Then the flask was immersed in a thermostated oil bath at 80° C. for at least 17 hours. Subsequently, the reaction mixture was centrifuged at 10,000 rpm for 30 min and the supernatant was replaced by THF followed by the redispersion of the nanoparticles. This centrifugation/redispersion step was repeated two times to yield PDMS-grafted silica nanoparticles. The thus PDMS grafted silica nanoparticles were dried in vacuum at room temperature. The presence of PDMS was confirmed with FTIR spectroscopy. By thermo gravimetric analysis the amount of PDMS-G grafted to the silica nanoparticles was determined to be 9.4% wt. The grafting density was calculated and determined to be 0.3 PDMS chains per nm².

### Experiment 9

### Functionalization of Nanoparticles by Attaching Polystyrene Grafts to Silica Particles

In a 100 ml round bottom flask, 100 ml ethanol and 2.0 g silica particles obtained via a method as described in method 1 of Experiment 1 and having an average particle size of 80 nm, were added followed by sonication for one hour. After sonication, the flask was equipped with a magnetic stirrer and stirred at 500 rpm. 10 ml (3-Aminopropyl)-trimethoxysilane (APTMS) was added and the mixture was stirred for 17 hours. Following centrifuging at 10,000 rpm for 30 min the silica particles were collected. The liquid was replaced by clean ethanol and the particles were redispersed to remove the unreacted APTMS. After centrifuging at 10,000 rpm for 30 min the particles were collected again. This washing procedure was repeated once more, after which the APTMS-functionalized silica particles were collected and dried in vacuum at room temperature for at least 2 hours.

In a 100 ml round bottom flask, 1.5 g APTMS-functionalized particles were redispersed in 75 ml toluene by 30 min of sonication. The flask was equipped with a magnetic stirrer and cooled to 0° C. while stirring. 15 ml of triethylamine (TEA) was added to the mixture, after which 5 ml of α-bromo-isobutyrylbromide was added dropwise during 30 min. The mixture was stirred for 17 hours. After centrifuging at 10,000 rpm for 30 min the silica particles were collected. The liquid was replaced by clean ethanol to remove unreacted TEA, α-bromo isobutyrylbromide and the salt formed by TEA and HBr. The particles were redispersed by 15 min of sonication. After centrifuging at 10,000 rpm for 30 min the particles were collected again. This washing step was repeated once after which the particles were dried in vacuum at room temperature for about 2 hours. The particles contain immobilized alkyl bromide that acts as atom transfer radical polymerization (ATRP) initiator.

In a 50 ml round bottom flask, 1.0 g ATRP initiator-functionalized particles were redispersed in 10 ml DMF by 30 min of sonication. Two other flasks were prepared, one with 156 mg CuBr and 24.3 mg CuBr₂ and another one with 16.87 ml DMF, 12.5 ml styrene and 459 μl PMDETA (N,N,N′,N″,N″-pentamethyldiethylene triamine). All three flasks were equipped with magnetic stirrers and stopped with a rubber septum through which they were purged with argon for one hour. The styrene solution was added to the CuBrCuBr₂ mixture which was purged with argon and stirred at 500 rpm for one hour. This mixture of monomer and CuBrCuBr₂ was added to the particle dispersion after which the reaction flask was submerged into an 90° C. thermostated oil bath and stirred at 400 rpm for 18 hours under argon atmosphere, yielding polystyrene grafts onto the silica nanoparticles. The molecular weight of the polystyrene grafts was about 30,000 Dalton.

Following centrifuging at 10,000 rpm for 30 min the polystyrene-grafted particles were collected. These particles are referred to as SiO₂—PS. The liquid was replaced by clean DMF to remove residual CuBr. After further purification with THF the particles were collected and dried in vacuum at room temperature for about 2 hours. The presence of polystyrene grafts was confirmed with FTIR. By thermal gravimetric analysis the amount of polystyrene grafted from the silica nanoparticles was determined to be 40% wt. The grafting density was calculated and determined to be 0.3.

### Experiment 10

To assess the effect of the various nanoparticles the nanoparticles of experiments 6 to 9 were subjected to the forming of a polystyrene composite as described in Experiment 4 (the nanoparticles being present in an amount of 4% wt) and subsequently to a series of foaming experiments which were effected as described in Experiment 5, with the exception that the foaming temperature was 110° C. The results are shown in Table 2 below. The silanol-functionalized particles are referred to as SiO₂-x, wherein x is the number of the relevant Experiment.

TABLE 2

| Exp. | | polymer | Grafting | amount of | Cell size, | Cell density, |
|---|---|---|---|---|---|---|
| No. | Silica | graft | density, nm⁻² | nanoparticles, % wt | μm | 10¹² cells/ml |
| 10a | — | — | — | — | 2.1 | 0.2 |
| 10b | SiO₂-6 | — | — | 4 | 1.4 | 0.9 |
| 10c | SiO₂-7 | PDMS | 0.07 | 4 | 0.6 | 3.4 |
| 10d | SiO₂-8 | PDMS | 0.3 | 4 | 0.5 | 4.0 |
| 10e | SiO₂-9 | PS | 0.3 | 4 | 1.0 | 1.2 |

The results show that the grafts result in smaller cell sizes and higher cell densities. Moreover, the comparison of the results of experiments 10d and 10e shows that the use of a polydimethylsiloxane graft with a low surface energy with respect to the polystyrene foam matrix yields an advantageous effect on the cell size and cell density.

1. Polymer foam comprising a polymer and nanoparticles having a maximum dimension of 750 nm, which foam has cells with an average cell size of at most 1 μm according to ASTM D 3576 and a cell density of at least 10¹² cells/ml, wherein polymeric grafts have been attached to the nanoparticles.

2. Foam according to claim 1, wherein the nanoparticles are porous hollow core-shell particles with a maximum dimension of 750 nm.

3. Foam according to claim 1, wherein the nanoparticles comprise a substance selected from metals, metal oxides metal salts and combinations thereof.

4. Foam according to claim 3, wherein the nanoparticles comprise a substance selected from the metals, oxides and salts of Ca, Mg, Zr, Ti, Zn, Sn, Ce, Fe, Al, Cs, Cu, Ag and combinations thereof, including calcium carbonate, magnesium oxide, ferric oxide and ferrous oxide, caesium oxide, cerium oxide, cupric oxide, cuprous oxide and silver oxide.

5. Foam according to claim 1, wherein the nanoparticles comprise a substance selected from silica, alumina, titania, zirconia, and combinations thereof.

6. Foam according to claim 1, wherein the grafts comprise a polymer chain having a length ranging from 400 to 100,000 Dalton.

7. Foam according to claim 1, wherein the grafts have been made of a polymer selected from polystyrene, polyacrylate, polymethacrylate, polyurethanes, polyalkylene oxides, polyolefins, polyethylene, polypropylene and polybutylene, silicones, polydimethylsiloxanes, and combinations thereof.

8. Foam according to claim 24, wherein the grafts contain halogen atoms.

9. Foam according to claim 8, wherein the grafts comprise fluorine substituents.

10. Foam according to claim 9, wherein the fluorine substituents-containing polymeric grafts comprise perfluoropolyalkylene oxide moieties.

11. Foam according to claim 3, wherein a particle surface has been modified before the polymeric grafts are attached to the core.

12. Foam according to claim 11, wherein the particle surface has been modified by covalent derivatization of the particle with a low surface energy compound before the grafts were attached.

13. Foam according to claim 11, wherein the particle surface has been modified by applying a silane compound, or a fluorine substituent containing silane compound, on the surface.

14. Foam according to claim 1, wherein the nanoparticles have an aspect ratio of at most 10.

15. Foam according to claim 1, wherein the nanoparticles are substantially spherical.

16. Foam according to claim 15, wherein the nanoparticles comprise substantially spherical silica particles.

17. Foam according to claim 1, wherein the amount of nanoparticles in the foam ranges from 0.1 to 95% wt, based on the combination of polymer and nanoparticles.

18. Foam according to claim 1, wherein the cells have an average cell size of at most 750 nm.

19. Foam according to claim 1, which comprises a polymer matrix and wherein the polymer matrix is comprised of polyolefins, polyesters, polystyrene, polyacrylates, polymethacrylates, polyalkylene oxides, polyurethanes, polyamides or combinations thereof.

20. (canceled)

21. A method for the manufacture of polymer foam, comprising:
dispersing nanoparticles having a maximum dimension of 750 nm that comprise a core to which polymeric grafts have been attached and, wherein the polymeric grafts have been made of a polymer selected from polystyrene, polyacrylate, polymethacrylate, polyolefins, polyethylene, polypropylene, polybutylene, polyurethanes, polyalkylene oxides, silicones, polydimethylsiloxanes, or combinations thereof, or that comprise porous hollow core-shell silica particles to which these polymeric grafts have been attached in a polymer to yield a dispersion;
adding a blowing agent to the dispersion to obtain an expandable mixture; and
foaming the expandable mixture to obtain the polymer foam.

22. The method according to claim 21, wherein the blowing agent comprises a physical blowing agent selected from carbon dioxide, nitrogen, water, argon and low-boiling hydrocarbons, propane, butane, pentane and/or a chemical blowing agent selected from sodium bicarbonate and azobicarbonamide.

23. (canceled)

24. Foam according to claim 1, wherein the grafts have been made of a substituted polymer selected from polystyrene, polyacrylate, polymethacrylate, polyurethanes, polyalkylene oxides, polyolefins, preferably polyethylene, polypropylene and polybutylene, silicones, polydimethylsiloxanes, and combinations thereof.

25. Foam according to claim 1, wherein the cells have an average cell size of at most 550 nm.

26. A method for the manufacture of polymer foam, comprising:
dispersing nanoparticles having a maximum dimension of 750 nm that comprise a core to which polymeric grafts have been attached and, wherein the polymeric grafts have been made of a substituted polymer selected from polystyrene, polyacrylate, polymethacrylate, polyolefins, polyethylene, polypropylene, polybutylene, polyurethanes, polyalkylene oxides, silicones, polydimethylsiloxanes, or combinations thereof or that comprise porous hollow core-shell silica particles to which these polymeric grafts have been attached in a polymer to yield a dispersion;
adding a blowing agent to the dispersion to obtain an expandable mixture; and
foaming the expandable mixture to obtain the polymer foam.

27. Polymer foam according to claim 1, obtained by:
(A) (1) dispersing nanoparticles having a maximum dimension of 750 nm that comprise a core to which polymeric grafts have been attached and, wherein the polymeric grafts have been made of a polymer selected from polystyrene, polyacrylate, polymethacrylate, polyolefins, polyethylene, polypropylene, polybutylene, polyurethanes, polyalkylene oxides, silicones, polydimethylsiloxanes, or combinations thereof, or that comprise porous hollow core-shell silica particles to which these polymeric grafts have been attached in a polymer to yield a dispersion;
(2) adding a blowing agent to the dispersion to obtain an expandable mixture; and
(3) foaming the expandable mixture to obtain the polymer foam; or
(B) (1) dispersing nanoparticles having a maximum dimension of 750 nm that comprise a core to which polymeric grafts have been attached and, wherein the polymeric grafts have been made of a substituted polymer selected from polystyrene, polyacrylate, polymethacrylate, polyolefins, polyethylene, polypropylene, polybutylene, polyurethanes, polyalkylene oxides, silicones, polydimethylsiloxanes, or combinations thereof or that comprise porous hollow core-shell silica particles to which these polymeric grafts have been attached in a polymer to yield a dispersion;
(2) adding a blowing agent to the dispersion to obtain an expandable mixture; and
(3) foaming the expandable mixture to obtain the polymer foam.
